(19) United States
(12) Patent Application Publication
(10) Pub. No.: US 2005/0204101 A1
(43) Pub. Date: Sep. 15, 2005

(54) Partial dual-port memory and electronic device using the same

(75) Inventor: Yukio Fukuzo, Kawasaki (JP)

Correspondence Address: YOUNG & THOMPSON, 745 SOUTH 23RD STREET, 2ND FLOOR, ARLINGTON, VA, 22202, US

(73) Assignee: NEC ELECTRONICS CORPORATION, KAWASAKI (JP)

(21) Appl. No.: 11/079,304

(22) Filed: Mar. 15, 2005

(30) Foreign Application Priority Data
Mar. 15, 2004 (JP) 2004-073586

(51) Int. Cl. G06F 12/00

(52) U.S. Cl. 711/149; 711/170

(57) ABSTRACT

A partial dual-port memory used for an electronic device such as a mobile phone includes a storage area with a given capacity. The storage area has a first area accessed only by a first processor, a second area accessed only by a second processor, and a common area having two ports, shared by the first and the second processors, and simultaneously accessible via the two ports.

### BACKGROUND OF THE INVENTION

1. Field of the Invention

The present invention relates to a partial dual-port memory and an electronic device using this memory. Particularly, the invention relates to a partial dual-port memory suitable for use in an electronic device having a plurality of processors and facing the necessity of reducing the size and weight, such as a mobile phone with a camera function, and an electronic device using this memory.

2. Description of Related Art

Electronic devices such as mobile phones face the necessity of reducing the size and weight. Recent mobile phones have a camera function, videophone function, and so on in addition to normal communication functions. Such mobile phones have a communication central processing unit (CCPU) for controlling data communication with a wireless base station, an application central processing unit (ACPU) for processing software of applications such as a camera function and a ringing melodies function, and a memory for storing various data.

This type of conventional mobile phone has an antenna 1, a wireless communication section 2, a button operation section 3, a CPU 4, a camera section 5, a digital signal processor (DSP) 6, a static random access memory (SRAM) 7, an arbiter 8, an interface (I/F) 9, a gold/gold ball 10, and a synchronous dynamic random access memory (SDRAM) 11, for example, as shown in FIG. 8. The wireless communication section 2 transmits and receives a wireless electric wave W to and from a wireless base station, which is not shown, via the antenna 1. The button operation section 3 is composed of a transmission key, a conversion key of English/Katakana/Kanji/Number, a power on/off key, a cross key for cursor control, an end key, and so on. The CPU 4 functions as the CCPU and also controls the entire mobile phone.

The camera section 5 is composed of a charge coupled device (CCD) camera or the like to take the image in the vicinity of the mobile phone. The DSP 6 functions as the ACPU and processes the image signal shot by the camera section 5. The SRAM 7 is composed of memory cells each of which has six elements consisting of four transistors and two resistors or consisting of six transistors. The SRAM 7 stores data shared by the CPU 4 and the DSP 6, which is image data having processed by the DSP 6, for example. The arbiter 8 arbitrates simultaneous access from the CPU 4 and the DSP 6 to the SDRAM 11 via the interface 9 so as to avoid conflict. The gold/gold ball 10 makes contacts between the input/output port of the interface 9 and the input/output port of the SDRAM 11. The SDRAM 11 is a double data rate (DDR) type DRAM composed of memory cells each of which has two elements consisting of one transistor and one capacitor. The SDRAM 11 exchanges data with the CPU 4 or the DSP 6 in synchronization with both rise and fall edges of an external clock signal in order to double the data transfer efficiency without increasing the clock frequency.

This type of technique is also disclosed in Japanese Unexamined Patent Application Publication No. 59-129989 (Ikeda). Ikeda teaches a dual-port dynamic random access memory which is composed of 2T-1C memory cells, each consisting of two transfer gates and one capacitor. Each memory cell has two separated access paths, thereby avoiding the exclusive use of a data bus if suitably operated.

The present invention, however, has recognized that the above memory used for a mobile phone has the following problems.

Since the arbiter 8 arbitrates simultaneous access to the SDRAM 11 by the CPU 4 and the DSP 6, it impedes high-speed processing.

Further, though the memory taught by Ikeda can eliminate the exclusive use of a data bus, it does not allow high-speed processing.

### SUMMARY OF THE INVENTION

According to one embodiment of the present invention, there is provided a partial dual-port memory which has a storage area with a given capacity. The storage area includes a first area accessed only by a first processor, a second area accessed only by a second processor, and a common area having two ports, shared by the first and the second processors, and simultaneously accessible via the two ports.

According to another embodiment of the present invention, there is provided an electronic device using the above partial dual-port memory.

According to still another embodiment of the present invention, there is provided a mobile phone using the above partial dual-port memory.

According to yet another embodiment of the present invention, there is provided a mobile phone which includes a digital signal processor (DSP) processing an image signal and generating image data, a partial dual-port memory storing the image data generated by the DSP, and a central processing unit (CPU) reading the image data from the partial dual-port memory and transmitting the image data to a base station. The partial dual-port memory includes a storage area with a given capacity which includes a first area accessed only by the DSP, a second area accessed only by the CPU, and a common area having two ports, shared by the DSP and the CPU, and simultaneously accessible via the two ports.

Since this invention places the common area shared by the first processor and the second processor and simultaneously accessible by the two processors, it achieves a higher integration density of a memory and a higher speed data transmission compared with the case when the first area and the second area are all composed of 2T-1C memory cells. This allows reducing the size and weight of mobile phones even if they are highly functional and require a high-capacity memory. Further, since the first area is accessed only by the first processor and the second area is accessed only by the second processor, no conflict occurs between the first and second processors, and a time loss by the arbiter is kept to the minimum, thus permitting high-speed processing.

### BRIEF DESCRIPTION OF THE DRAWINGS

The above and other objects, advantages and features of the present invention will be more apparent from the following description taken in conjunction with the accompanying drawings, in which:

FIG. 1 is a block diagram showing the electric structure of a substantial part of an electronic device using a partial dual-port memory of an embodiment of the invention;

FIG. 2 is a block diagram showing the electric structure of a CLK synchronous SRAM I/F in FIG. 1;

FIG. 3 is a diagram showing a structural example of a first DRAM cell array, a dual-port DRAM cell array, and a second DRAM cell array in FIG. 1;

FIG. 4 is a diagram showing the electric structure of a memory cell constituting the first and the second DRAM cell arrays in FIG. 3;

FIG. 5 is a diagram showing the electric structure of a memory cell constituting the dual-port DRAM cell array in FIG. 3;

FIG. 6 is a diagram showing the state of a substantial part when writing data to a PDPRAM in FIG. 1;

FIG. 7 is a diagram showing the state of a substantial part when reading data from the PDPRAM in FIG. 1; and

FIG. 8 is a block diagram showing the electric structure of a substantial part of a conventional electronic device.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

A partial dual-port memory of this invention includes a first area which is accessed only by a first processor, a second area which is accessed only by a second processor, and a common area which is shared by the first and the second processors and which can be simultaneously accessed.

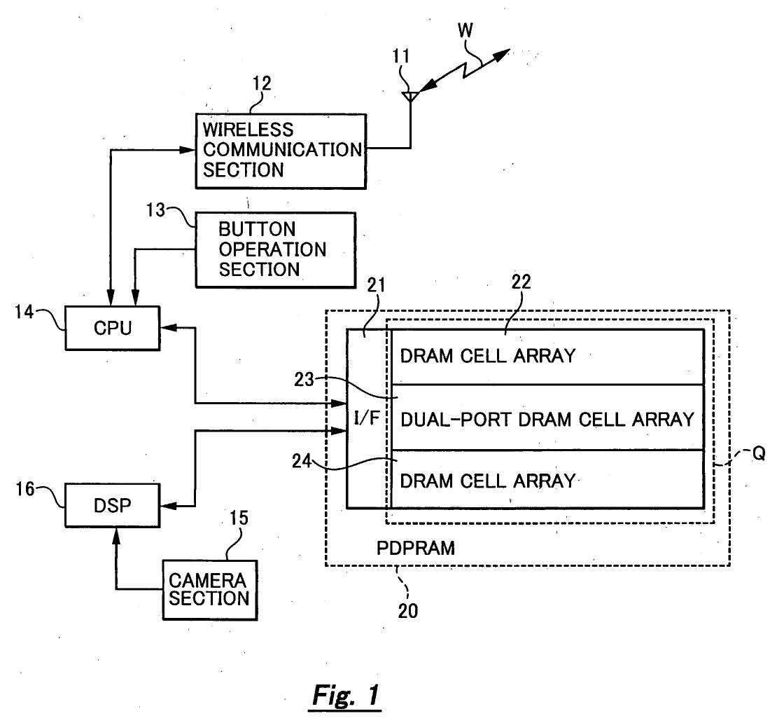

FIG. 1 shows the electric structure of a substantial part of an electronic device using a partial dual-port memory of an embodiment of the invention. The electronic device of this example is a mobile phone which includes an antenna 11, a wireless communication section 12, a button operation section 13, a CPU 14, a camera section 15, a DSP 16, and a partial dual-port random access memory (PDPRAM) 20. The wireless communication section 12 transmits and receives a wireless electric wave W to and from a wireless base station, which is not shown, via the antenna 11. The button operation section 13 is composed of a transmission key, a conversion key of English/Katakana/Kanji/Number, a power on/off key, a cross key for cursor control, an end key, and so on. The CPU 14 controls the communication with the wireless base station and also controls the entire mobile phone. The camera section 15 is composed of a CCD camera or the like to take the image in the vicinity of the mobile phone. The DSP 16 processes software of applications such as a camera function and a ringing melodies function. In this embodiment, the DSP 16 processes the image signal shot by the camera section 15.

The PDPRAM 20 has a storage area with a given capacity and includes a clock (CLK) synchronous SRAM interface (I/F) 21, a DRAM cell array 22, a dual-port DRAM cell array 23, and a DRAM cell array 24. The CLK synchronous SRAM I/F 21 allows the PDPRAM 20, which is based on DRAM memory cells, to operate as a pseudo SRAM (PSRAM). The PSRAM, though based on DRAM memory cells, includes a SRAM-type control section to operate like SRAM. Since it is not necessary to input addresses separately by row address and column address to the PSRAM, there is no need for timing signals such as row address strobe (RAS) and column address strobe (CAS). The PSRAM, just like SRAM, only requires one-time input of an address and it takes in the address triggered by a chip enable signal, which is relevant to a clock of a clock synchronous memory, and reads or writes data.

The DRAM cell array 22 is accessed only by the CPU 14. The dual-port DRAM cell array 23 is shared by the CPU 14 and the DSP 16. The dual-port DRAM cell array 23 has two ports and can be simultaneously accessed by the CPU 14 and the DSP 16 via each port. The DRAM cell array 24 is accessed only by the DSP 16. In this embodiment, the CLK synchronous SRAM I/F 21, the DRAM cell array 22, the dual-port DRAM cell array 23, and the DRAM cell array 24 are incorporated into one chip Q.

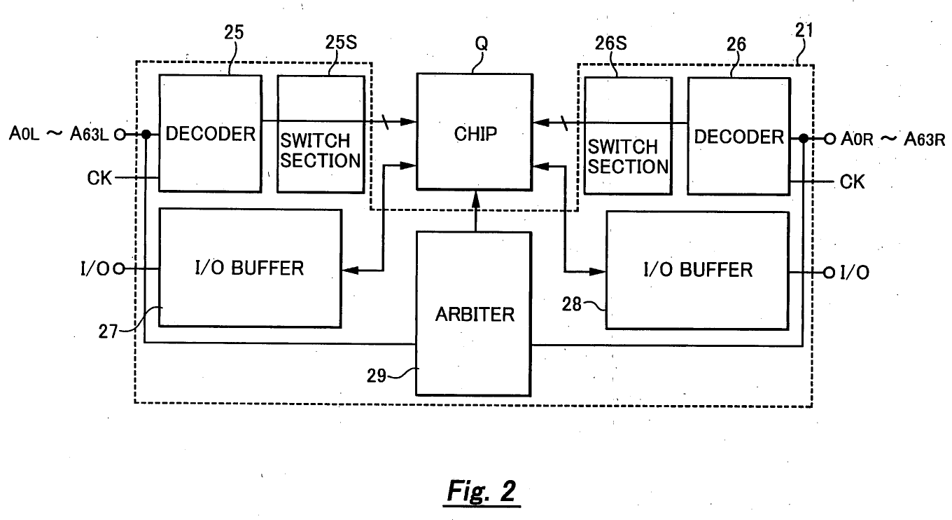

FIG. 2 shows the electric structure of the CLK synchronous SRAM I/F 21 in FIG. 1. The CLK synchronous SRAM I/F 21 includes decoders 25, 26, input/output (I/O) buffers 27, 28, and an arbiter 29. These elements are connected to the chip Q composed of the DRAM cell array 22, the dual-port DRAM cell array 23, and the DRAM cell array 24. The decoder 25 selects the address of one port of a memory cell of the dual-port DRAM cell array 23 or the address of a memory cell of the DRAM cell array 22 in synchronization with a clock “ck” according to the access from the CPU 14 or input of address data A0L to A63L. On the other hand, the decoder 26 selects the address of the other port of a memory cell of the dual-port DRAM cell array 23 or the address of a memory cell of the DRAM cell array 24 in synchronization with the clock “ck” according to the access from the DSP 16 or input of address data A0R to A63R.

The I/O buffer 27 causes one port of the dual-port DRAM cell array 23 and the DRAM cell array 22 to operate like SRAM and functions as a data I/O interface with the CPU 14. The I/O buffer 28 causes the other port of the dual-port DRAM cell array 23 and the DRAM cell array 24 to operate like SRAM and functions as a data I/O interface with the DSP 16. The arbiter 29 arbitrates simultaneous access from the decoder 25 and the decoder 26 to the dual-port DRAM cell array 23 so as to avoid conflict.

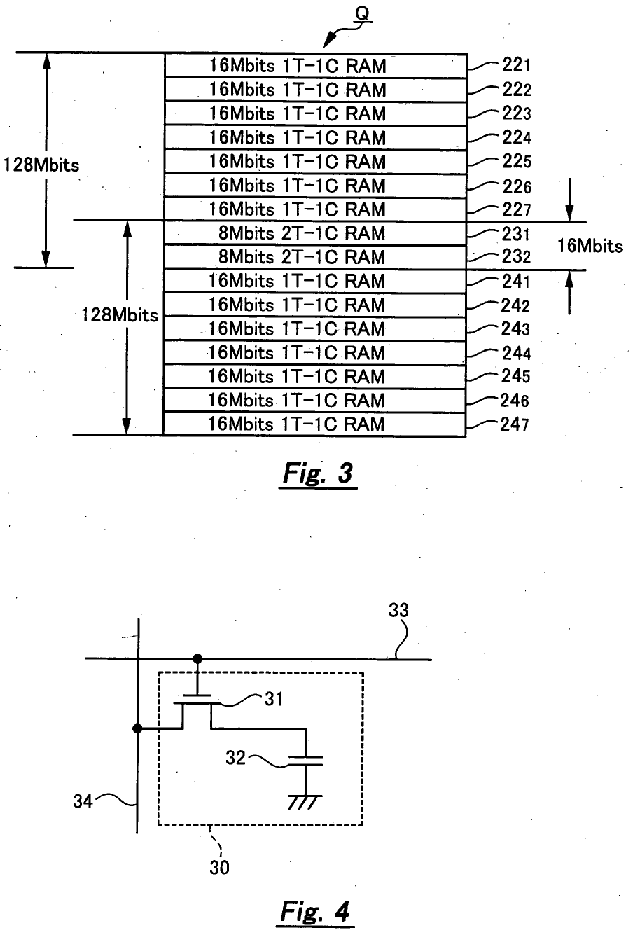

FIG. 3 shows a structural example of the DRAM cell array 22, the dual-port DRAM cell array 23, and the DRAM cell array 24 in FIG. 1. The DRAM cell array 22 includes memory blocks 22₁, 22₂, . . . to 22₇. The memory block 22₁ is composed of 1T-1C memory cells, each consisting of one first transfer gate and one first capacitor. The first transfer gate is ON/OFF controlled based on access from the CPU 14. The first capacitor is charged when the first transfer gate is ON to store information. The capacity of the memory block 22₁ is 16 Mbits, for example. The memory blocks 22₂ to 22₇ have the same structure as the memory block 22₁.

The DRAM cell array 24 includes memory blocks 24₁, 24₂, . . . to 24₇. The memory block 24, is composed of 1T-1C memory cells, each consisting of one second transfer gate and one second capacitor. The second transfer gate is ON/OFF controlled based on access from the DSP 16. The second capacitor is charged when the second transfer gate is ON to store information. The capacity of the memory block 24₁ is 16 Mbits, for example. The memory blocks 24₂ to 24₇ have the same structure as the memory block 24₁.

The dual-port DRAM cell array 23 includes memory blocks 23₁ and 23₂. The memory block 23₁ is composed of 2T-1C memory cells, each consisting of a third transfer gate, a fourth transfer gate, and a third capacitor. The third transfer gate is ON/OFF controlled based on access from the CPU 14. The fourth transfer gate is ON/OFF controlled based on access from the DSP 16. The third capacitor is charged when the third or the fourth transfer gate is ON to store information. The capacity of the memory block 23₁ is 8 Mbits, for example. The memory block 23₂ has the same structure as the memory block 23₁. The DRAM cell array 22, the dual-port DRAM cell array 23, and the DRAM cell array 24 are incorporated into one chip with a total capacity of 256 Mbits. Though a 2T-1C memory cell is about twice the size or area of a 1T-1C memory cell, since the area of the 16-Mbit 1T-1C memory cell and the area of the 8-Mbit 2T-1C memory cell are substantially the same, this 256-Mbit memory cell is substantially the same size as a 256-Mbit 1T-1C memory cell, and the number of capacitors is: 256M-16M.

FIG. 4 shows the electric structure of a memory cell constituting the DRAM cell arrays 22 and 24 of FIG. 3. The memory cell 30 has a MOS transistor 31 used as the first or the second transfer gate and a capacitor 32. The memory cell 30 is formed at a crossing point of a selection line 33 with a signal line 34. The MOS transistor 31 is ON/OFF controlled according to the address data supplied from the decoder 25 or 26 of FIG. 2 through the selection line 33. The capacitor 32 is charged when the MOS transistor 31 is ON according to the data supplied from the I/O buffer 27 or 28 of FIG. 2 through the signal line 34 and thereby stores information.

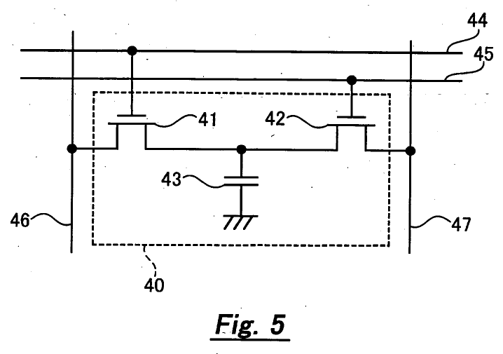

FIG. 5 shows the electric structure of a memory cell constituting the dual-port DRAM cell array 23 of FIG. 3. The memory cell 40 has MOS transistors 41 and 42 used as the third and the fourth transfer gates and a capacitor 43. The memory cell 40 is formed at a crossing point of selection lines 44 and 45 with signal lines 46 and 47. The MOS transistor 41 is ON/OFF controlled according to the address data supplied from the decoder 25 of FIG. 2 through the selection line 44. The MOS transistor 42 is ON/OFF controlled according to the address data supplied from the decoder 26 of FIG. 2 through the selection line 45. The capacitor 43 is charged when the MOS transistor 41 is ON according to the data supplied from the I/O buffer 27 of FIG. 2 through the signal line 46 and thereby stores information. The capacitor 43 is also charged when the MOS transistor 42 is ON according to the data supplied from the I/O buffer 28 of FIG. 2 through the signal line 47 and thereby stores information.

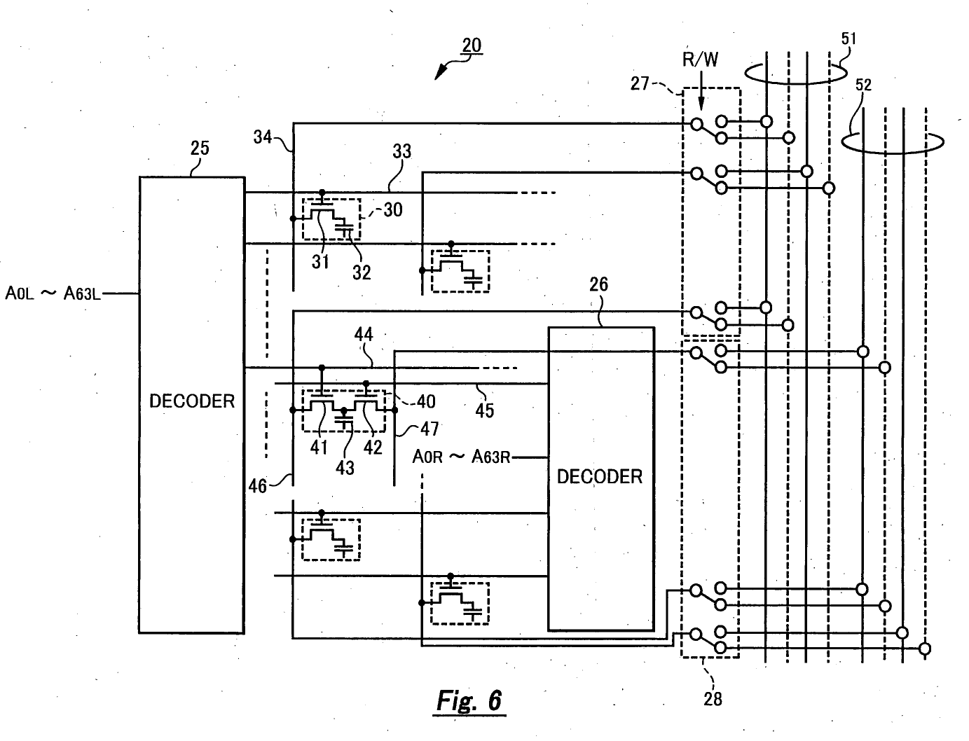

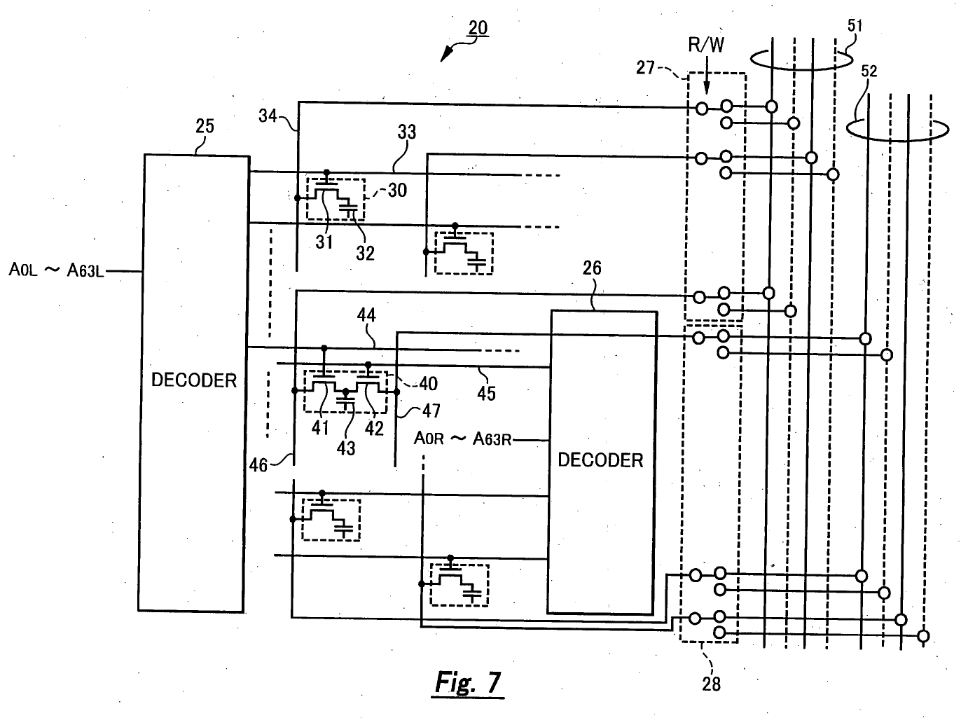

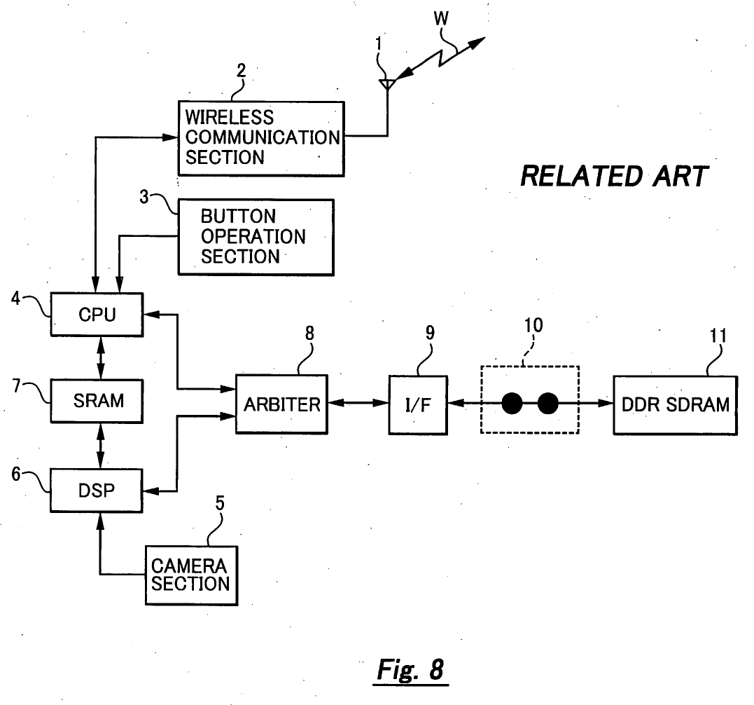

FIG. 6 shows the state of a substantial part when writing data to the PDPRAM 20. FIG. 7 shows the state of the substantial part when reading data from the PDPRAM 20. Referring to those drawings, the operation of a mobile phone using the partial dual-port memory of this embodiment is described hereinafter.

In this mobile phone, the camera section 15 takes a surrounding image, for example, and the DSP 16 processes the image signal. The DSP 16 then makes access to the address of one port of the dual-port DRAM cell array 23 of the PDPRAM 20 via the decoder 26 to store the processed image data therein. In this case, as shown in FIG. 6, for example, in response to a read/write control signal R/W from a control section, which is not shown, the signal line 47 is connected via the I/O buffer 28 to an upper bit write-line, which is shown by a dotted line in an upper line group 52 in FIGS. 6 and 7. Further, the MOS transistor 42 is turned ON according to the address data supplied from the decoder 26 through the selection line 45, thereby charging the capacitor 43 with the image data.

When reading out the stored image data, the CPU 14 makes access to the address of the other port of the dual-port DRAM cell array 23 via the decoder 25 and reads the data. In this case, as shown in FIG. 7 for example, in response to a read/write control signal R/W from the control section, the signal line 46 is connected via the I/O buffer 27 to a lower bit read-line, which is shown by a full line in the lower line group 51 in FIGS. 6 and 7. Further, the MOS transistor 41 is turned ON based on the address data supplied from the decoder 25 through the selection line 44, thereby discharging the capacitor 43. The image data is then transmitted from the wireless communication section 12 to a wireless base station, which is not shown, by a wireless electric wave W via the antenna 11. If the decoder 25 and the decoder 26 simultaneously access the dual-port DRAM cell array 23, the arbiter 29 arbitrates the access so as to avoid conflict.

The CPU 14 makes access to the address of the memory cell of the DRAM cell array 22 via the decoder 25 to input or output data via the I/O buffer 27. In this case, as shown in FIG. 6 for example, in response to a read/write control signal R/W, the signal line 34 is connected via the I/O buffer 27 to a lower bit write-line, which is shown by a dotted line in the lower line group 51 in FIGS. 6 and 7. Further, the MOS transistor 31 is turned ON based on the address data supplied from the decoder 25 through the selection line 33, thereby charging the capacitor 32 with the data. On the other hand, as shown in FIG. 7, in response to a read/write control signal R/W, the signal line 34 is connected via the I/O buffer 27 to the lower bit read-line, and the MOS transistor 31 is turned ON based on the address data supplied from the decoder 25 through the selection line 33, thereby discharging the capacitor 32.

The DSP 16 makes access to the address of the memory cell of the DRAM cell array 24 via the decoder 26 to input or output data via the I/O buffer 28. In this case also, the operation shown in FIGS. 6 and 7 is performed in the same way.

As described in the foregoing, since this embodiment uses the dual-port DRAM cell array 23 shared by the CPU 14 and the DSP 16 and simultaneously accessible by them, it achieves a higher integration density of a memory and a higher speed data transmission compared with the case when the DRAM cell arrays 22 and 24 are all composed of 2T-1C memory cells. This allows reducing the size and weight of mobile phones even if they are highly functional and require a high-capacity memory. Further, since the DRAM cell array 22 is accessed only by the CPU 14 and the DRAM cell array 24 is accessed only by the DSP 16, no conflict occurs between the CPU 14 and the DSP 16, and a time loss by the arbiter 29 is kept to the minimum, thus permitting high-speed processing.

Though an embodiment of the invention is described above in detail with reference to the drawings, specific structures are not limited to those described above. For example, the CPU 14 makes access to the address of the memory cell of the dual-port DRAM cell array 23 or the DRAM cell array 22 via the decoder 25, and the DSP 16 makes access to the address of the memory cell of the dual-port DRAM cell array 23 or the DRAM cell array 24 via the decoder 26 in the above embodiment; however, it is possible to configure the memory blocks 22₁ to 22₇ constituting the DRAM cell array 22 as bank memories supplied with common address data so that only the bank memory selected by a selection signal is accessed. Similarly, it is possible to configure the memory blocks 24₁ to 24₇ constituting the DRAM cell array 24 as bank memories supplied with common address data so that only the bank memory selected by a selection signal is accessed. Further it is possible to configure the memory blocks 23₁ and 23₂ constituting the dual-port DRAM cell array 23 as bank memories supplied with common address data so that only the bank memory selected by a selection signal is accessed.

Although the above embodiments describe the case where this invention is applied to a mobile phone, it is applicable to every electronic device having a plurality of processors and facing the necessity of reducing the size and weight, such as personal digital assistants (PDA).

It is apparent that the present invention is not limited to the above embodiment that may be modified and changed without departing from the scope and spirit of the invention.

1. A partial dual-port memory comprising a storage area with a given capacity, the storage area comprising:
a first area accessed only by a first processor;
a second area accessed only by a second processor; and
a common area having two ports, shared by the first and the second processors, and simultaneously accessible via the two ports.

2. The partial dual-port memory of claim 1, further comprising:
a memory cell array comprising a plurality of memory cells corresponding to the capacity of the storage area;
a first decoder selecting an address of one port of a memory cell assigned to the common area or an address of a memory cell assigned to the first area according to access from the first processor; and
a second decoder selecting an address of the other port of the memory cell assigned to the common area or an address of a memory cell assigned to the second area according to access from the second processor.

3. The partial dual-port memory of claim 2, further comprising an arbiter arbitrating simultaneous access from the first decoder and the second decoder to the common area so as to avoid conflict.

4. The partial dual-port memory of claim 2, wherein
the memory cell assigned to the first area comprises a first transfer gate ON/OFF controlled according to access from the first processor, and a first capacitor charged when the first transfer gate is ON to store information,
the memory cell assigned to the second area comprises a second transfer gate ON/OFF controlled according to access from the second processor, and a second capacitor charged when the second transfer gate is ON to store information, and
the memory cell assigned to the common area comprises a third transfer gate ON/OFF controlled according to access from the first processor, a fourth transfer gate ON/OFF controlled according to access from the second processor, and a third capacitor charged when the third or the fourth transfer gate is ON to store information.

5. The partial dual-port memory of claim 1, wherein the first area, the second area, and the common area are incorporated into one chip.

6. An electronic device using the partial dual-port memory of claim 1.

7. A mobile phone using the partial dual-port memory of claim 1.

8. A mobile phone comprising:
a digital signal processor (DSP) processing an image signal and generating image data;
a partial dual-port memory storing the image data generated by the DSP; and
a central processing unit (CPU) reading the image data from the partial dual-port memory and transmitting the image data to a base station,
wherein the partial dual-port memory comprises a storage area with a given capacity which includes a first area accessed only by the DSP, a second area accessed only by the CPU, and a common area having two ports, shared by the DSP and the CPU, and simultaneously accessible via the two ports.

9. The mobile phone of claim 8, wherein the partial dual-port memory further comprises:
a memory cell array comprising a plurality of memory cells corresponding to the capacity of the storage area;
a first decoder selecting an address of one port of a memory cell assigned to the common area or an address of a memory cell assigned to the first area according to access from the DSP; and
a second decoder selecting an address of the other port of the memory cell assigned to the common area or an address of a memory cell assigned to the second area according to access from the CPU.
